(19) United States
(12) Patent Application Publication
(10) Pub. No.: US 2026/0141072 A1
(43) Pub. Date: May 21, 2026

(54) DYNAMIC DISTRIBUTION OF ON-DEVICE CONTROL SOFTWARE

(71) Applicant: Cisco Technology, Inc., San Jose, CA (US)

(72) Inventors: Jeffrey Yi Dar Lo, Cupertino, CA (US); Daniel Eric Talayco, Mountain View, CA (US); Robert Stephen Rodgers, Mountain View, CA (US); Kyle Andrew Donald Mestery, Woodbury, MN (US); Thomas John Giuli, Mountain View, CA (US); Thomas Vincent Flynn, Santa Clara, CA (US); Tong Liu, Waltham, MA (US)

(21) Appl. No.: 19/249,680

(22) Filed: Jun. 25, 2025

Related U.S. Application Data
(60) Provisional application No. 63/722,583, filed on Nov. 19, 2024.

(51) Int. Cl. G06F 21/57

(52) U.S. Cl. CPC G06F 21/572

(57) ABSTRACT

In various embodiments described herein, a method of dynamic software distribution and synchronization, includes identifying a software state change of a network device, generating a secure manifest configured for the network device, selecting a distribution strategy, propagating the secure manifest and one or more software objects, and receiving a synchronization report.

### CROSS-REFERENCE TO RELATED APPLICATION

This application claims the benefit of priority to U.S. Provisional Application No. 63/722,583, filed Nov. 19, 2024, the disclosure of which is incorporated by reference herein in its entirety.

The present disclosure relates to communication networks. More particularly, the present disclosure relates to dynamically and securely upgrading agents on network devices for the automatic distribution of agents to customer devices transparently.

### BACKGROUND

A network fabric is a highly interconnected architecture of switches and routers in data centers or enterprise environments, forming a grid that enables efficient, high-speed data transfer across various components such as servers, storage devices, and applications. By linking devices directly or in closely connected layers, a network fabric facilitates seamless communication and can reduce bottlenecks. A common topology used within network fabrics to ensure efficient, high-speed data transfer is a leaf-spine architecture. In this system, “spine” switches act as the network backbone, connecting to all “leaf” switches, which in turn connect directly to servers and other end devices, providing direct paths to destinations within the network fabric to minimize latency and allow the network to scale.

Cloud controllers may add another layer of efficiency and centralization to network fabrics, allowing for the remote management of network resources and the automation of complex networking tasks. A cloud controller for a network fabric can be a centralized system that manages and coordinates the various networking components within a cloud environment, often acting as the “brain” for a network. In many embodiments, the cloud controller is a software-based management tool accessible through the internet, providing a high-level, centralized view of all activity and performance within the network. This comprehensive view may allow the cloud controller to make real-time adjustments to optimize data flow and simplify management, as many routine tasks can be automated, reducing the need for manual intervention.

Integrating demanding workloads, such as those associated with artificial intelligence (AI), into network fabrics leverages the low-latency, high-throughput nature of these systems to support data-heavy and computation-intensive tasks. However, completing such an integration can come with significant challenges. The complexity of configuring specific networking requirements within a data center can be daunting, and handling the massive data transfers and low-latency demands can strain even well-designed network fabrics, leading to potential bottlenecks. Additionally, security and data governance concerns can be heightened, requiring robust measures to protect and monitor data flows, while scaling the network to accommodate expanding demands can lead to compatibility and performance issues.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of a network fabric with network devices in accordance with various embodiments of the disclosure;

FIG. 2 is a block diagram illustrating data proxying between network device and a cloud controller in accordance with various embodiments of the disclosure;

FIG. 3 is a schematic block diagram of an example leaf-spine network fabric in accordance with various embodiments of the disclosure;

FIG. 4 is a conceptual network diagram of various environments that a dynamic software distribution and synchronization logic may operate, in accordance with various embodiments of the disclosure;

FIG. 5 is a conceptual timing diagram for an agent software upgrade process in accordance with various embodiments of the disclosure;

FIG. 6 is a flowchart depicting a process for software distribution and synchronization in accordance with various embodiments of the disclosure;

FIG. 7 is a flowchart depicting a process for cloud controller-side software distribution and synchronization in accordance with various embodiments of the disclosure;

FIG. 8 is a flowchart depicting a process for device-side software distribution and synchronization in accordance with various embodiments of the disclosure; and

FIG. 9 is a conceptual block diagram of a device suitable for configuration with a dynamic software distribution and synchronization logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DESCRIPTION OF EXAMPLE EMBODIMENTS

### Overview

In some embodiments, a method of dynamic software distribution and synchronization, includes identifying a software state change of a network device, generating a secure manifest configured for the network device, selecting a distribution strategy, propagating the secure manifest and one or more software objects, and receiving a synchronization report.

In some embodiments, a device includes a processor, and a memory communicatively coupled to the processor, wherein the memory includes a dynamic software distribution and synchronization logic. The logic is configured to receive a secure manifest, authenticate the secure manifest, retrieve one or more software objects, execute a state synchronization process to apply one or more software objects, validate the one or more software objects, generate a synchronization report, and transmit the synchronization report.

### Example Embodiments

In response to the issues described above, devices and methods are discussed herein that dynamically and securely upgrading agents on network devices for the automatic distribution of agents to customer devices transparently. A network fabric is a highly interconnected system of networking devices, like switches and routers, designed to create a grid-like structure within a data center or enterprise network. This interconnectedness allows data to move quickly and seamlessly between various components, such as servers, storage devices, and applications, without a single point of congestion. The fabric structure enables high-speed, low-latency communication across the network, making it especially suited for environments that handle large amounts of data or require rapid processing, such as AI workloads and cloud services. Essentially, a network fabric supports efficient and resilient data flow by linking all parts of the network in a cohesive, scalable way.

Within network fabric environments, a leaf and spine system is a network topology commonly used within the network fabric to ensure efficient, high-speed data transfer across a data center. In this setup, the “spine” switches are positioned as the backbone of the network, connecting to all “leaf” switches, which in turn connect directly to servers and other end devices. Unlike traditional hierarchical networking, where data may travel through multiple layers, a leaf and spine system can provide direct paths to any destination within the network fabric. This design may minimize bottlenecks, reduce latency, and allow the network to scale horizontally. In other words, adding more spine switches or leaf nodes can increase capacity without degrading performance. By connecting every leaf switch to each spine switch, the system can maintain fast and consistent data flow, making it an ideal framework for a network fabric that supports large-scale, data-intensive applications, such as, for example, AI applications.

A cloud controller for a network fabric is a centralized system that manages and coordinates the various networking components within a cloud environment. It can act as the “brain” for a network, ensuring that all parts work together seamlessly. In many embodiments, the cloud controller, can be configured as a software-based management tool accessible through the internet, allowing IT teams to manage and control the network remotely. Its role can be to oversee the network fabric, providing a high-level, centralized view of all the activity and performance within the network. With this comprehensive view, the cloud controller can make real-time adjustments to optimize data flow across the network fabric. For example, if one part of the network becomes congested, the controller can identify less busy routes and reroute data to maintain fast, uninterrupted performance.

In a number of embodiments, a cloud controller for a network fabric can simplify management significantly. Without it, each device would need to be configured and monitored individually, which would be complex and time-intensive, especially as the network grows. The controller may also enable scalability by automatically integrating new devices or resources into the network fabric as they're added. Additionally, many routine tasks, such as balancing network traffic or troubleshooting, can be automated, reducing the need for manual intervention and making network management much faster and more efficient.

In a variety of embodiments, an AI-focused network fabric can include a cloud-managed solution designed to simplify the deployment and management of AI infrastructure for enterprises. It can integrate pre-existing network resources with various graphical processing units (GPUs) and data processing units (DPUs), network switches, optics-based devices, specialized data storage, and other AI Enterprise software, forming a cohesive stack aimed at facilitating generative AI applications. This integration can enable organizations to manage their AI infrastructure's lifecycle from design to deployment and ongoing operations, all through a centralized cloud platform.

In more embodiments, an AI-focused network fabric system can offer AI-native capabilities, including design-before-you-buy tools, comprehensive guidance, and plug-and-play deployment, all managed through the cloud. It may further include assertion-based monitoring to promptly identify and address issues, ensuring efficient operation of AI infrastructure. In this way, an AI-focused network fabric can enable enterprises to distribute AI workloads across various business needs and use cases, streamlining the AI adoption process.

As those skilled in the art will recognize, when managing an on-premises network fabric via a cloud controller, ensuring the software is up to date can be a challenge. Typically, software upgrades of the code can be handled by users, with redundancy built into the network to handle entire device upgrades. However, this can be tricky as it means the user has to manage these upgrades. Downtime has to be scheduled, and as a result, software lags. This is made harder as the cloud controller attempts to manage the number of versions it has to work with. Various embodiments described herein address this problem by allowing the cloud controller to download new agent software to the devices and seamlessly upgrade those devices on the devices themselves.

In some embodiments, the cloud controller is able to verify agent software versions during communication, and indicate to the agents that they should upgrade their software. In more embodiments, the communication on when to upgrade can happen in various scenarios. In some embodiments, it can occur upon initial connection from the agent to the cloud. In additional embodiments, the new software can be pushed to the cloud containing new agent software, the cloud controller will tell connected agents to upgrade. In still more embodiments, the gateway nodes will cache software updates for the rest of the fabric. This can allow for more efficient use of outbound traffic from the cloud, resulting in lower costs for the cloud controller operators. By locally caching software on the devices, the agents can more efficiently upgrade devices in the fabric. In certain embodiments, systems described herein can push an entire device firmware, including the network operating system.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

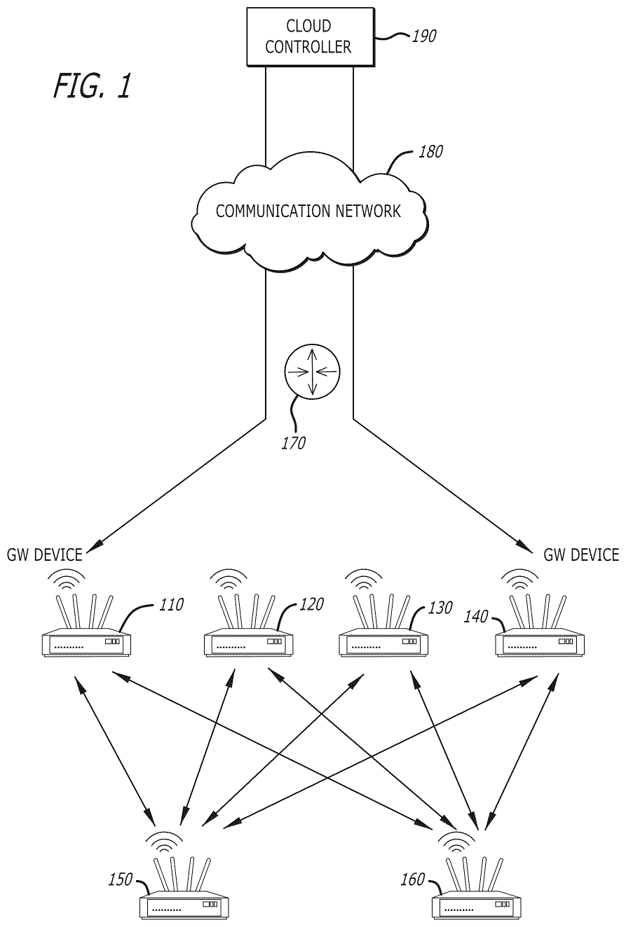

Referring to FIG. 1, a conceptual illustration of a network fabric with network devices in accordance with various embodiments of the disclosure is shown. The network may comprise a cloud controller 190, a communication network 180, a router 170, a plurality of gateway devices including a first gateway device 110, a second gateway device 120, a third gateway device 130, and a fourth gateway device 140, and a plurality of network devices including a first network device 150 and a second network device 160. In the embodiment depicted, all of these devices may be interconnected, which can be representative of a network fabric that is centrally managed by the cloud controller 190.

In many embodiments, the cloud controller 190 may be configured to provide centralized oversight and control for the network fabric. The cloud controller 190 may connect to the fabric by way of the communication network 180 and a router 170. In some embodiments, the communication network 180 can be the internet, and the router 170 may be an edge router. This connectivity allows the cloud controller 190 to identify a required software state change on any device within the fabric and orchestrate the distribution of secure manifests and software updates to bring the device into compliance.

The devices within the fabric may be configured with different roles. In some embodiments, the first gateway device 110, the second gateway device 120, the third gateway device 130, and the fourth gateway device 140 can all function as gateway devices. These gateway devices may serve as exit nodes for the fabric, providing connectivity to the external communication network 180. The first network device 150 and the second network device 160 may be interconnected within the fabric and can rely on the gateway devices for external communication with the cloud controller 190. This can create a two-tiered structure within the fabric.

In certain embodiments, each of the gateway devices and network devices may be configured with software agents, such as a proxy agent, to facilitate hop-by-hop data traffic forwarding. Furthermore, one or more of the gateway devices, such as the first gateway device 110 or the second gateway device 120, may be configured to act as a local caching agent. A local caching agent can store software objects received from the cloud controller 190. This allows for the efficient local distribution of those software objects to other devices in the fabric, such as the first network device 150, thereby reducing the need for each device to download the objects directly from the cloud controller 190.

This network architecture allows for the dynamic and secure management of software across the entire fabric. As an authoritative source, the cloud controller 190 can generate and propagate a secure manifest for a target device, such as the first network device 150. The manifest and its associated software objects may be propagated through a gateway device, like the first gateway device 110. The first network device 150 can then receive this information, execute or otherwise satisfy a state synchronization process, and transmit a synchronization report back to the cloud controller 190. This centralized control allows the cloud controller 190 to ensure that all devices in the fabric are running correct and secure software versions.

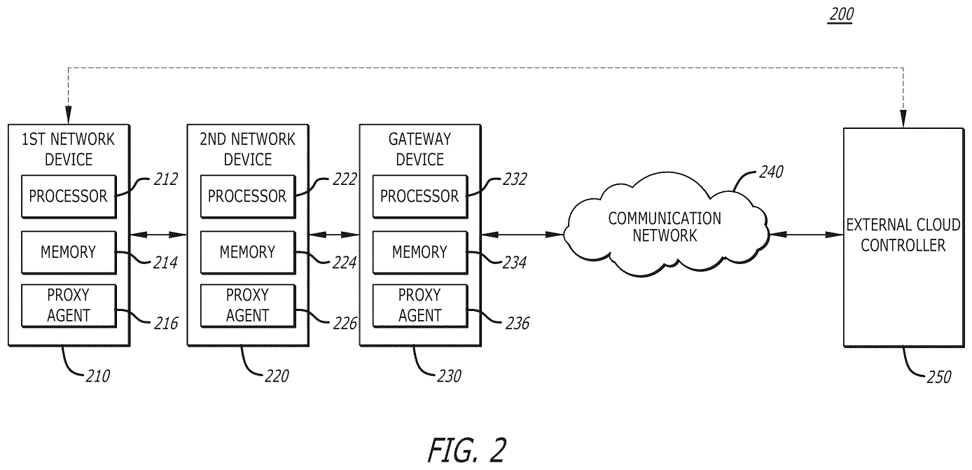

Although a specific embodiment for a network fabric with network devices for carrying out the various steps, processes, methods, and operations described herein is discussed with respect to FIG. 1, any of a variety of systems and/or processes may be utilized in accordance with embodiments of the disclosure. For example, while a two-tiered fabric of gateway and network devices is shown, other fabric topologies such as a full leaf-spine architecture could be implemented where some or all leaf switches act as gateway devices. The elements depicted in FIG. 1 may also be interchangeable with other elements of FIGS. 2-9 as required to realize a particularly desired embodiment.

Referring to FIG. 2, a block diagram illustrating data proxying between network devices and a cloud controller in accordance with various embodiments of the disclosure is shown. The system 200 may comprise a first network device 210, a second network device 220, a gateway device 230, a communication network 240, and an external cloud controller 250. The embodiment depicted in FIG. 2 illustrates how a network device that may not have direct access to an external network can establish a logical connection with a cloud controller by routing communications through one or more intermediary devices within a network fabric.

In many embodiments, each device may comprise internal components to facilitate this process. For instance, the first network device 210 may comprise a first processor 212, a first memory 214, and a first proxy agent 216. Similarly, the second network device 220 may comprise a second processor 222, a second memory 224, and a second proxy agent 226, and the gateway device 230 may comprise a third processor 232, a third memory 234, and a third proxy agent 236. The proxy agents, such as the first proxy agent 216, the second proxy agent 226, and the third proxy agent 236, may be configured to function as temporary relay points, enabling data traffic to be forwarded hop-by-hop through the network.

The process of establishing a connection for a device like the first network device 210 may be initiated through this proxying mechanism. In some embodiments, the first network device 210 may need to connect to the external cloud controller 250 but may not have a direct link to the communication network 240. The first network device 210 can discover that the second network device 220 is a neighboring device that can provide a path towards a gateway. In this case, the first network device 210 can transmit a connection request, which can be received and forwarded by the second proxy agent 226 on the second network device 220 to the gateway device 230.

In further embodiments, the third proxy agent 236 on the gateway device 230 can then forward this connection request over the communication network 240 to the external cloud controller 250. The gateway device 230 may first establish its own secure connection with the external cloud controller 250, performing authentication and potentially receiving a session cookie. This proxied handshake can allow the first network device 210 to establish a logical end-to-end connection with the external cloud controller 250, as depicted by the dashed line. Once this logical connection is in place, data can flow in both directions. For example, a secure manifest from the external cloud controller 250 can be proxied through the gateway device 230 and the second network device 220 to reach the first network device 210. Likewise, a synchronization report from the first network device 210 can be proxied along the reverse path back to the controller.

This hop-by-hop proxying model can enhance the resilience and flexibility of the network fabric. It may be particularly useful in environments where not all devices have direct external connectivity or where routing is not yet fully established for a new device. It can allow devices to be added to the fabric and become managed by the cloud controller with minimal initial configuration, as they only need to find a communication path through a neighbor. This ensures that the external cloud controller 250 can maintain visibility and manage devices across the entire network, even those on the outer edges of the topology.

Although a specific embodiment for data proxying between network devices and a cloud controller for carrying out the various steps, processes, methods, and operations described herein is discussed with respect to FIG. 2, any of a variety of systems and/or processes may be utilized in accordance with embodiments of the disclosure. For example, while two intermediary devices are shown, the proxying mechanism could be extended across any number of hops required for a network device to reach a gateway. The elements depicted in FIG. 2 may also be interchangeable with other elements of FIGS. 1 and 3-9 as required to realize a particularly desired embodiment.

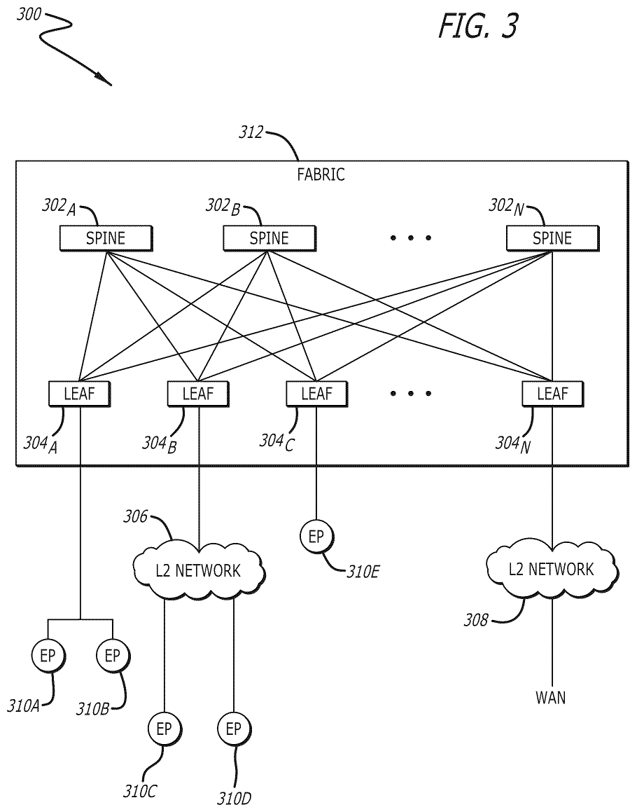

Referring to FIG. 3, a schematic block diagram of an example leaf-spine network fabric in accordance with various embodiments of the disclosure is shown. The architecture 300 may comprise a network fabric 312, which can include a plurality of spine switches, such as a first spine switch 302A, a second spine switch 302B, up to an Nth spine switch 302N. The network fabric 312 may also comprise a plurality of leaf switches, including a first leaf switch 304A, a second leaf switch 304B, a third leaf switch 304C, up to an Nth leaf switch 304N. This type of topology may be designed to provide a flexible and scalable infrastructure for data centers and other network environments.

In many embodiments, the first spine switch 302A, the second spine switch 302B, and the Nth spine switch 302N may be configured to form the core or backbone of the network fabric 312. The primary function of the spine switches can be to connect to all of the leaf switches within the fabric, as depicted by the interconnecting lines. The spine switches may be L3 switches in some embodiments, but they may also be configured to perform L2 functionalities. In certain embodiments, one or more of the spine switches can be configured to host a proxy function that performs a lookup of an endpoint address identifier on behalf of leaf switches that do not have such a mapping.

In further embodiments, the first leaf switch 304A, the second leaf switch 304B, the third leaf switch 304C, and the Nth leaf switch 304N may reside at the edge of the network fabric 312. These leaf switches can provide fabric ports for uplinks to the spine switches, as well as access ports that provide connectivity for various endpoints and external networks. The leaf switches can be top-of-rack switches, or they may be aggregation switches in end-of-row or middle-of-row topologies. In addition to providing connectivity, the leaf switches may be responsible for routing and bridging packets and for applying network policies.

The leaf switches may provide access to the network fabric 312 for various endpoints and networks. For instance, a first endpoint 310A and a second endpoint 310B may connect directly to the first leaf switch 304A. Similarly, a fifth endpoint 310E can connect directly to the third leaf switch 304C. In some embodiments, connections may be indirect. For example, a third endpoint 310C and a fourth endpoint 310D may connect to the second leaf switch 304B by way of a first L2 network 306. Additionally, an external Wide Area Network (WAN) can connect to a leaf switch, such as the Nth leaf switch 304N, through a second L2 network 308. These endpoints can be any communication device, such as a server or computer, that may host applications or services.

In the context of the present disclosure, this leaf-spine architecture provides a structured environment for the dynamic management of software. A remote cloud controller may be configured to identify a required software state change for any of the spine switches or leaf switches. For example, a secure manifest could be generated for the first leaf switch 304A. The manifest and its associated software objects could then be propagated through the fabric, potentially being cached on a spine switch like the first spine switch 302A, before being retrieved and applied by the first leaf switch 304A. This architecture is well-suited for the efficient and resilient distribution of software updates, which can be beneficial for supporting demanding applications running on the connected endpoints.

Although a specific embodiment for an example leaf-spine network fabric for carrying out the various steps, processes, methods, and operations described herein is discussed with respect to FIG. 3, any of a variety of systems and/or processes may be utilized in accordance with embodiments of the disclosure. For example, while the endpoints are shown connecting to the leaf switches, in certain embodiments, endpoints could also connect to spine switches, or the fabric could be part of a larger multi-site network architecture. The elements depicted in FIG. 3 may also be interchangeable with other elements of FIGS. 1, 2, and 4-9 as required to realize a particularly desired embodiment.

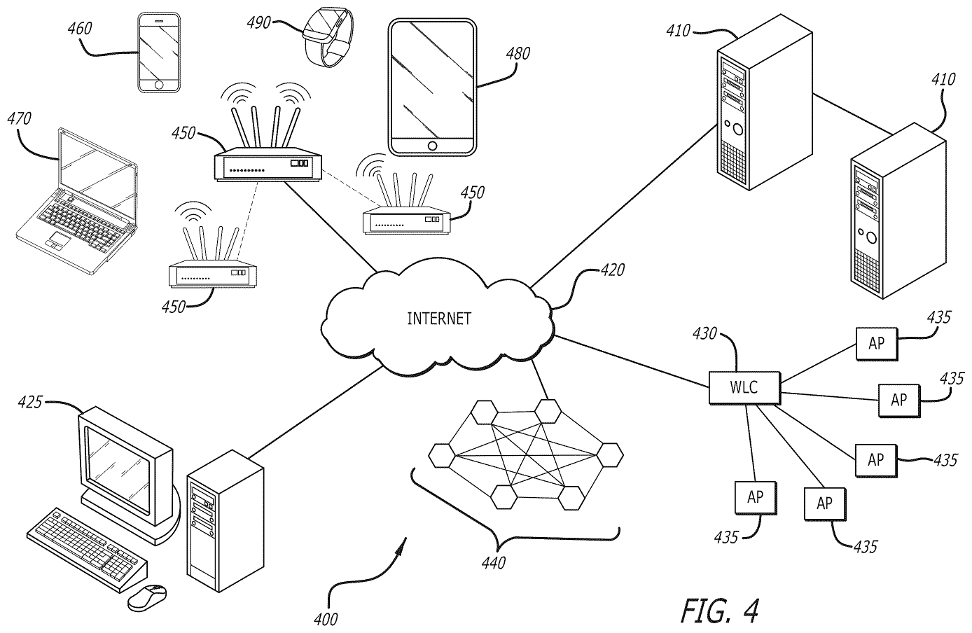

Referring to FIG. 4, a conceptual network diagram of various environments that a dynamic software distribution and synchronization logic may operate, in accordance with various embodiments of the disclosure is shown. This diagram 400 depicts a plurality of computing devices and network infrastructure components that can be interconnected. These components may represent potential environments where the functionalities for managing software state, such as those provided by the dynamic software distribution and synchronization logic, can be deployed in a variety of models, including locally, remotely, or in a distributed fashion.

In many embodiments, the dynamic software distribution and synchronization logic may be deployed in a centralized or cloud-based model. For instance, the controller component of the logic could reside on a central entity, such as servers 410, or it could operate as a cloud service accessible via the internet 420. This cloud service could be part of a larger AI or machine-learning environment, represented by a neural network symbol 440. From this central location, the logic could be configured to generate secure manifests and manage the software state of remote network devices across the entire environment, such as a wireless local-area network (LAN) controller (WLC 430) or access points 450.

In some embodiments, the logic may be deployed in a distributed or hierarchical fashion. A primary controller logic may reside in the cloud, while local instances of the logic, such as a component configured to act as a caching agent, could be deployed on-premise on a device like the servers 410 or a dedicated gateway appliance. This local instance could then manage the efficient distribution of software objects to other devices within its local network segment, such as the WLC 430 and its managed access points, which include a plurality of access points 435. This can reduce the reliance on the internet 420 for every software object transfer.

The targets of the dynamic software distribution and synchronization logic may be the various network infrastructure devices whose software state is being managed. This can include the access points 450, the WLC 430, and the servers. The seamless and reliable operation of the software on these infrastructure devices directly contributes to a stable and secure network experience for various end-user devices. These end-user devices can include a first smart phone 460, a first laptop computer 470, a first tablet computer 480, and a first smart watch 490, which may connect to the network through the managed access points.

The environment depicted in FIG. 4 can illustrate the flexibility of the deployment models for the disclosure. The dynamic software distribution and synchronization logic is not necessarily confined to a single location. A hybrid approach can be used where a primary controller logic operates in the cloud, generating manifests and defining target states, while local synchronization and caching logic resides on-premise to execute the updates efficiently. This allows the system to balance the benefits of centralized control with the efficiency of local, distributed execution. A workstation 425 could be used by a network administrator to interact with the central controller to define policies or monitor the synchronization status of the managed devices.

Although a specific embodiment for various environments that a dynamic software distribution and synchronization logic may operate for carrying out the various steps, processes, methods, and operations described herein is discussed with respect to FIG. 4, any of a variety of systems and/or processes may be utilized in accordance with embodiments of the disclosure. For example, the dynamic software distribution and synchronization logic could be deployed in a fully on-premise model where the servers 410 act as the primary controller for all other devices within a private network, without relying on the public internet 420 for control plane communication. The elements depicted in FIG. 4 may also be interchangeable with other elements of FIGS. 1-3 and 5-9 as required to realize a particularly desired embodiment.

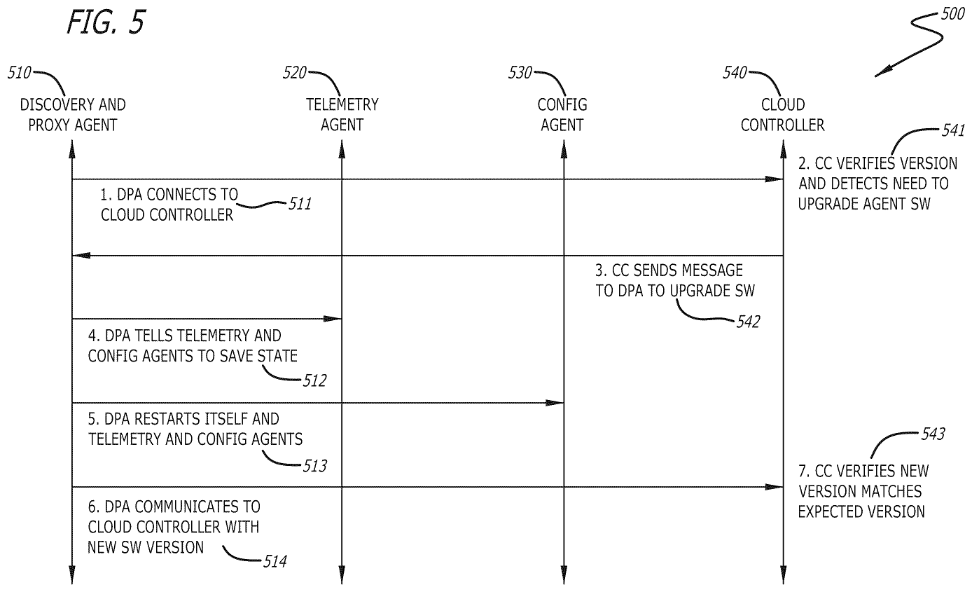

Referring to FIG. 5, a conceptual timing diagram for an agent software upgrade process in accordance with various embodiments of the disclosure is shown. The timing diagram 500 illustrates a sequence of interactions for a software upgrade process for one or more agents that may be operating on a network device. The actors involved in this process can include a discovery and proxy agent (DPA 510), a telemetry agent 520, a config agent 530, and a cloud controller 540. The diagram shows a coordinated approach that may be used to ensure software agents can be upgraded in a structured and resilient manner, which can be part of a broader software state synchronization process.

In many embodiments, the upgrade sequence may be initiated by the cloud controller 540. The process can begin when the DPA 510 connects to the cloud controller 540 (Step 1, 511). In response to this connection, the cloud controller 540 may be configured to verify the current software version of the DPA 510 and detect that an upgrade to the agent software is necessary (Step 2, 541). This detection can be part of a larger process where the cloud controller identifies a required software state change for the device. Upon determining that an upgrade is needed, the cloud controller 540 can send a message to the DPA 510 with an instruction to upgrade its software (Step 3, 542).

In further embodiments, upon receiving the upgrade command, the agents on the device may take action to preserve their operational state. The DPA 510 can be configured to notify other agents, such as the telemetry agent 520 and the config agent 530, to save their current state (Step 4, 512). This state preservation can ensure that important operational data or configuration information is not lost during the upgrade and restart process. After instructing the other agents, the DPA 510 may then proceed to restart itself, along with the telemetry agent 520 and the config agent 530, which allows the new software version to be applied (Step 5, 513).

In certain embodiments, the upgrade process may conclude with a final verification. Once the restart is complete, the DPA 510, which can now be running the upgraded software, may reconnect and communicate to the cloud controller 540 with its new software version (Step 6, 514). This communication can serve as part of a synchronization report. Finally, the cloud controller 540 can be configured to verify that the new software version of the DPA 510 matches the expected version (Step 7, 543). This final verification can complete the upgrade loop and confirm that the device's agent software has been successfully synchronized to the desired state.

The timing diagram 500 illustrates one embodiment of a software update process, which in this case is focused on the software agents running on a network device. This sequence shows a direct, message-based interaction between the cloud controller 540 and the DPA 510. In some embodiments, this agent upgrade process could be orchestrated as one part of a larger state synchronization process that is dictated by a secure manifest. For instance, a manifest received by the device could specify the target software versions for the DPA 510, the telemetry agent 520, and the config agent 530, thereby triggering a similar sequence of state preservation and restart actions.

Although a specific embodiment for an agent software upgrade process for carrying out the various steps, processes, methods, and operations described herein is discussed with respect to FIG. 5, any of a variety of systems and/or processes may be utilized in accordance with embodiments of the disclosure. For example, while three distinct agents are shown, a similar process could be applied to a device running a single monolithic agent or a different combination of specialized agents. The elements depicted in FIG. 5 may also be interchangeable with other elements of FIGS. 1-4 and 6-9 as required to realize a particularly desired embodiment.

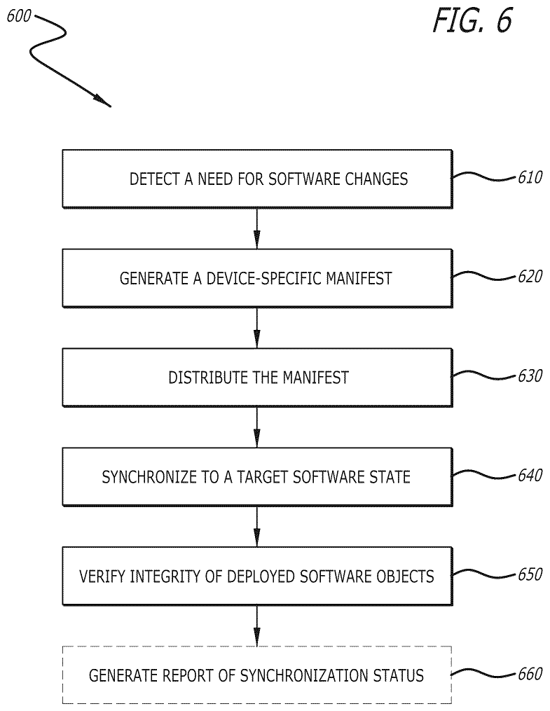

Referring to FIG. 6, a flowchart depicting a process for software distribution and synchronization in accordance with various embodiments of the disclosure is shown. In many embodiments, the process 600 can detect a need for software changes (block 610). For example, the need for a software change can be detected automatically by a cloud controller based on a predefined policy, such as a daily check for new security patches. In some embodiments, the need can be initiated manually by a network administrator who decides to deploy a new feature, thereby triggering the process for a fleet of devices.

In a number of embodiments, the process 600 can generate a device-specific manifest (block 620). The manifest can be generated to be non-portable by including a cryptographic signature that is specific to a target device's unique hardware identity, which can prevent the manifest from being used on an unauthorized device. It is contemplated that the manifest can be generated to include not only software version information but also one or more cryptographic hashes corresponding to required software objects.

In more embodiments, the process 600 can distribute the manifest (block 630). The distribution can occur directly from a cloud controller to a target network device over a wide area network. In certain embodiments, the distribution can be hierarchical, where the manifest is first sent to a local caching agent within the target device's network fabric, which can then distribute the manifest to the final target device.

In further embodiments, the process 600 can synchronize to a target software state (block 640). The synchronization can be executed immediately upon a device receiving and authenticating a manifest. For instance, a device may begin applying updates as soon as it validates the manifest's signature. In some embodiments, the synchronization can be scheduled for a later time, such as during a designated maintenance window, and the manifest itself could contain instructions regarding the timing of the synchronization.

In additional embodiments, the process 600 can verify integrity of deployed software objects (block 650). In a non-limiting example, the verification can be performed by calculating the cryptographic hash of a received software object and comparing it to a corresponding hash value specified in a manifest. The verification can also be part of a secure boot process, where the integrity of an entire software stack is validated against the manifest before the operating system is allowed to load.

In still more embodiments, the process 600 can generate report of synchronization status (block 660). The report can be configured to be a simple binary indicator of success or failure. In various embodiments, the report can be a detailed log containing information about each part of the synchronization process, including any errors encountered, the versions of software before and after the update, and the time taken, which can be transmitted to a cloud controller for auditing.

Although a specific embodiment for a process for software distribution and synchronization for carrying out the various steps, processes, methods, and operations described herein is discussed with respect to FIG. 6, any of a variety of systems and/or processes may be utilized in accordance with embodiments of the disclosure. For example, while the process is shown as a linear sequence, in some embodiments, certain actions such as distributing the manifest and distributing software objects could occur in parallel or in a different order. The elements depicted in FIG. 6 may also be interchangeable with other elements of FIGS. 1-5 and 7-9 as required to realize a particularly desired embodiment.

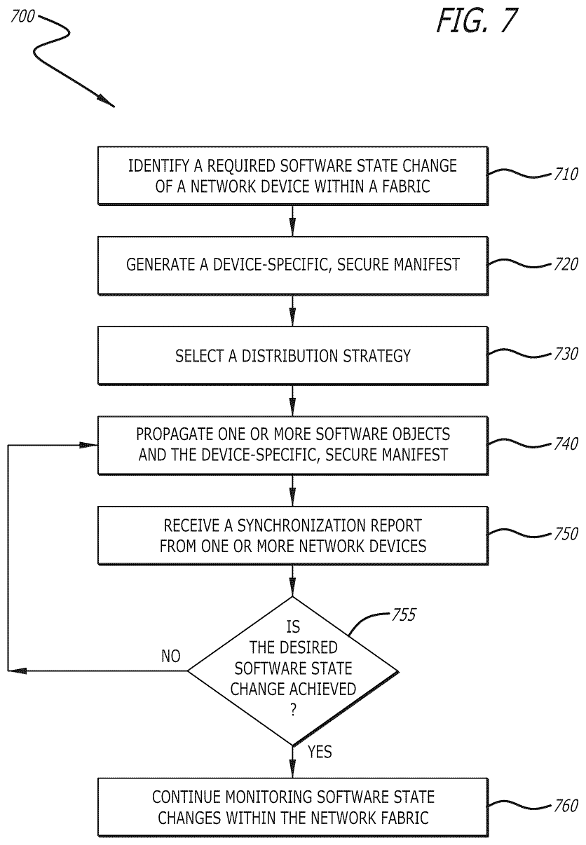

Referring to FIG. 7, a flowchart depicting a process for cloud controller-side software distribution and synchronization in accordance with various embodiments of the disclosure is shown. In many embodiments, the process 700 can identify a required software state change of a network device within a fabric (block 710). For example, this identification can be based on an automated audit where a cloud controller compares a reported software version from a device against a central policy or a latest version database. In some embodiments, the identification can be triggered by an administrator's action, such as defining a new network-wide security policy that requires a software update on all compatible devices.

In a number of embodiments, the process 700 can generate a device-specific, secure manifest (block 720). The manifest can be secured by being cryptographically signed using a key associated with a cloud controller, which allows a receiving device to verify the manifest's authenticity. It is contemplated that the manifest can also be made device-specific by tailoring its contents for a particular hardware model or a unique device identity to prevent the application of an incorrect software state.

In more embodiments, the process 700 can select a distribution strategy (block 730). In a non-limiting example, the strategy can be to use a direct distribution path, where software objects are propagated directly from a cloud controller to the target network device. This may be chosen for fabrics with high-speed internet connections. In certain embodiments, the strategy can be to leverage local caching by selecting a gateway device within the fabric to act as a local caching agent, thereby conserving external bandwidth.

In further embodiments, the process 700 can propagate one or more software objects and the device-specific, secure manifest (block 740). The propagation can involve sending only the manifest first, where the manifest contains identifiers and locations for the software objects that the target device can then use to retrieve the objects itself. In some embodiments, the propagation can involve sending the complete software objects along with the manifest in a single transaction.

In additional embodiments, the process 700 can receive a synchronization report from one or more network devices (block 750). The report can be received as a single, final summary after a device has completed its synchronization attempt, and this report could contain a simple success or failure status. In some embodiments, the report can be received periodically from the device as it executes the synchronization process, providing real-time status updates to a cloud controller.

In still more embodiments, the process 700 can determine if the desired software state change is achieved (block 755). This determination can be made by parsing the received synchronization report. If the report indicates the change was not achieved, the process 700 may once again propagate one or more software objects and the device-specific, secure manifest (block 740). For example, this re-propagation might involve selecting a different distribution strategy or using a corrected manifest. However, if the synchronization report indicates that the desired software state change has been successfully achieved, the process 700 can continue monitoring software state changes within the network fabric (block 760).

In yet more embodiments, the process 700 can continue monitoring software state changes within the network fabric (block 760). This monitoring can be a passive process, where a controller waits for new events or periodic reports from devices. In certain embodiments, the monitoring can be an active process, where the controller periodically polls devices or re-validates their software state against the known correct state to ensure no configuration drift has occurred.

Although a specific embodiment for a process for cloud controller-side software distribution and synchronization for carrying out the various steps, processes, methods, and operations described herein is discussed with respect to FIG. 7, any of a variety of systems and/or processes may be utilized in accordance with embodiments of the disclosure. For example, while the process shows a single loop for re-propagation, in some embodiments, a failure might trigger a different workflow, such as generating an alert for an administrator or quarantining the non-compliant device. The elements depicted in FIG. 7 may also be interchangeable with other elements of FIGS. 1-6, 8, and 9 as required to realize a particularly desired embodiment.

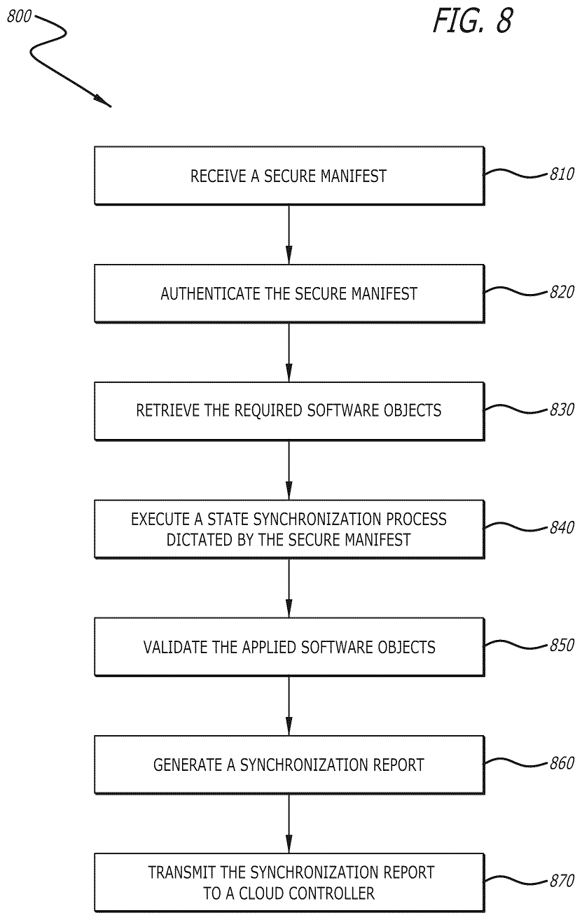

Referring to FIG. 8, a flowchart depicting a process for device-side software distribution and synchronization in accordance with various embodiments of the disclosure is shown. In many embodiments, the process 800 can receive a secure manifest (block 810). For example, the manifest can be received directly from a remote cloud controller over a wide area network connection. In some embodiments, the manifest can be received from a local caching agent operating within the device's own network fabric, such as from a gateway device.

In a number of embodiments, the process 800 can authenticate the secure manifest (block 820). Authentication can involve verifying a cryptographic signature of the manifest to ensure it originated from a trusted source, such as a cloud controller, and has not been tampered with in transit. It is contemplated that authentication can also include verifying that the manifest is intended for the specific device, for instance, by checking for a unique hardware identifier within the manifest's contents.

In more embodiments, the process 800 can retrieve the required software objects (block 830). The software objects can be retrieved from a remote repository managed by a cloud controller, using locations or Uniform Resource Locators specified within the manifest. In certain embodiments, the objects can be retrieved from a local caching agent within the network fabric, which can be faster and more efficient than retrieving them from a remote location.

In further embodiments, the process 800 can execute a state synchronization process dictated by the secure manifest (block 840). The execution can involve applying updates to an entire software stack, including a kernel or bootloader, as specified in the manifest. In a non-limiting example, the execution can involve a more granular update of individual software agents, which may include saving the state of existing agents prior to applying the newly retrieved software objects and then restarting the agents.

In additional embodiments, the process 800 can validate the applied software objects (block 850). Validation can be performed by calculating a cryptographic hash of a software object after it has been written to the device's memory or storage and comparing it to a corresponding hash value provided in the manifest to confirm integrity. In some embodiments, the validation can be performed as part of a post-reboot check to ensure that all applied components are functioning as expected.

In still more embodiments, the process 800 can generate a synchronization report (block 860). The report can be a concise summary, containing a final status, such as an indication of success or failure, and a new software version identifier. In various embodiments, the report can be a comprehensive log file detailing the outcome of each part of the synchronization process, including timestamps and any error codes encountered during execution.

In yet more embodiments, the process 800 can transmit the synchronization report to a cloud controller (block 870). The report can be transmitted immediately upon generation to provide timely feedback to a management system. It is contemplated that if the device cannot reach the cloud controller directly, the report can be transmitted via a proxy agent through one or more intermediary devices.

Although a specific embodiment for a process for device-side software distribution and synchronization for carrying out the various steps, processes, methods, and operations described herein is discussed with respect to FIG. 8, any of a variety of systems and/or processes may be utilized in accordance with embodiments of the disclosure. For example, if authenticating the secure manifest fails, the process could be configured to discard the manifest and transmit an error report immediately, rather than proceeding to retrieve software objects. The elements depicted in FIG. 8 may also be interchangeable with other elements of FIGS. 1-7 and 9 as required to realize a particularly desired embodiment.

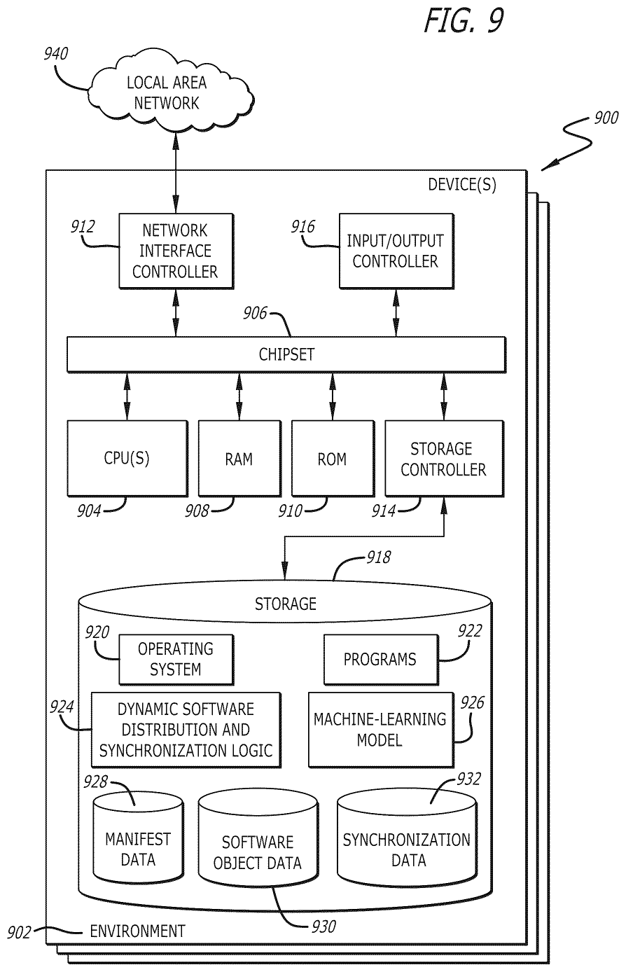

Referring to FIG. 9, a conceptual block diagram of a device 900 suitable for configuration with an dynamic software distribution and synchronization logic 924, in accordance with various embodiments of the disclosure is shown. The embodiment of the conceptual block diagram depicted in FIG. 9 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 9 can also illustrate an access point, a switch, or a router in accordance with various embodiments of the disclosure. The device 900 may, in many non-limiting examples, correspond to physical devices or to virtual resources described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, processor(s) 904, such as, but not limited to, central processing units (“CPUs”) can be configured to operate in conjunction with a chipset 906. The processor(s) 904 can be standard programmable CPUs that perform arithmetic and logical operations necessary for the operation of the device 900.

In a number of embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 906 may provide an interface between the processor(s) 904 and the remainder of the components and devices within the environment 902. The chipset 906 can provide an interface to a random-access memory (RAM 908), which can be used as the main memory in the device 900 in some embodiments. The chipset 906 can further be configured to provide an interface to a computer-readable storage medium such as a read-only memory (ROM 910) or non-volatile RAM (NVRAM) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

Additional embodiments of the device 900 can be configured to operate in a networked environment using logical connections to remote computing devices and computer systems through a network, such as the network 940. The chipset 906 can include functionality for providing network connectivity through a network interface card (NIC 912), which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for instance, store an operating system 920, applications 922, manifest data 928, software object data 930, and synchronization data 932. The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

In many more embodiments, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to device 900. Stated otherwise, some or all of the operations performed by the cloud computing network, and or any components included therein, may be performed by a device 900 or multiple operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In many additional embodiments, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as applications 922 and transform the device 900 by specifying how the processor(s) 904 can transition between states, as described above. In some embodiments, the device 900 has access to computer-readable storage media storing computer-executable instructions which, when executed by the device 900, perform the various processes described above with regard to FIGS. 1-7. In certain embodiments, the device 900 can also include computer-readable storage media having instructions stored thereupon for performing any of the other computer-implemented operations described herein.

In many embodiments, the dynamic software distribution and synchronization logic 924 can be configured to perform one or more of the various steps, processes, and operations described herein. When operating on a central management entity, such as a cloud controller, the dynamic software distribution and synchronization logic 924 can be configured to identify a required software state change for one or more network devices within a fabric. In response, the logic can generate a device-specific, secure manifest that is cryptographically signed and contains one or more cryptographic hashes corresponding to required software objects. The dynamic software distribution and synchronization logic 924 may then select an optimal distribution strategy, such as leveraging a local caching agent, and propagate the secure manifest and the software objects to the target device. Finally, the logic can be configured to receive and process a synchronization report from the network device to determine if the desired software state change has been achieved and to continue monitoring the state of the fabric.

When operating on a network device within the fabric, the dynamic software distribution and synchronization logic 924 may be configured to perform the device-side portion of the process. The logic can be configured to receive a secure manifest from a cloud controller or a local agent and authenticate it by verifying its cryptographic signature and ensuring it is intended for that specific device. Upon successful authentication, the logic can retrieve the required software objects from a designated location, such as a local cache, and validate their integrity using cryptographic hashes specified in the manifest. The dynamic software distribution and synchronization logic 924 may then execute a state synchronization process, which can involve complex actions such as saving the state of existing agents, applying the retrieved software objects to update components like the kernel or bootloader, and restarting services. After the process is complete, the logic can generate and transmit a synchronization report back to the cloud controller to provide feedback on the outcome

In many embodiments, the manifest data 928 can be configured to define or otherwise dictate a target software state for a device. The manifest data 928 can be generated by a cloud controller and may be device-specific, meaning it is tailored for a particular network device or hardware model. In certain embodiments, the manifest data 928 can be cryptographically signed to ensure its authenticity and integrity, and it may contain one or more cryptographic hashes that correspond to one or more required software objects. It is contemplated that the contents of the manifest data 928 can specify target versions for an entire software stack, including components such as a kernel, a bootloader, and various software agents.

The manifest data 928 may be used by a device to orchestrate a state synchronization process. A device can be configured to receive the manifest data 928 from a cloud controller or a local caching agent and then authenticate it to ensure it is valid and intended for that specific device. In some embodiments, the manifest data 928 can be used to facilitate a secure boot process, where the manifest's contents are used to override baked-in software components with updated, signed versions. Furthermore, it is contemplated that the manifest data 928 can include signed tokens that, when processed by the device, can change the device's operational behavior, such as placing it into a debug or demo mode.

In various embodiments, the software object data 930 may comprise the actual software components, files, or images that are distributed and applied to a device to achieve the target state defined in the manifest data 928. Examples of software object data 930 can include, but are not limited to, firmware images, kernel files, bootloader files, agent binaries, and other executable or configuration files. Each piece of software object data 930 can be identified by a unique cryptographic hash, which may be specified in the manifest data 928.

The software object data 930 can be retrieved by a device based on instructions contained within an authenticated manifest. In certain embodiments, the retrieval source for the software object data 930 can be a remote repository managed by a cloud controller. For greater efficiency and to conserve external bandwidth, in some embodiments, the software object data 930 can be retrieved from a local caching agent operating within the network fabric. After retrieval and application, the integrity of the software object data 930 can be validated by the device, for instance by comparing its calculated cryptographic hash against the hash value stored in the manifest data 928

In some embodiments, the synchronization data 932 may comprise data that is generated by a device during or after a state synchronization process. The content of the synchronization data 932 can be configured to be a concise summary, such as a simple indication of the success or failure of the synchronization attempt. In a non-limiting example, the synchronization data 932 can be a comprehensive log containing detailed information about the process, including timestamps, the results of authentication and validation checks, any error codes encountered, and the software versions on the device before and after the update.

The primary purpose of the synchronization data 932 can be to serve as a feedback mechanism to a central management system, such as a cloud controller. A cloud controller can be configured to receive and analyze the synchronization data 932, which may be sent in the form of a synchronization report, to determine if a desired software state change has been successfully achieved on a network device. It is contemplated that the synchronization data 932 can be transmitted from the device immediately upon generation or queued for later transmission, and it may be sent through one or more proxy agents if direct connectivity to the cloud controller is unavailable.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, input/output controllers 916 can be configured to provide output to a display, such as a computer monitor, a flat panel display, a digital projector, a printer, or other type of output device. Those skilled in the art will recognize that the device 900 might not include all of the components shown in FIG. 9 and can include other components that are not explicitly shown in FIG. 9 or might utilize an architecture completely different than that shown in FIG. 9.

As described above, the device 900 may support a virtualization layer, such as one or more virtual resources executing on the device 900. In some examples, the virtualization layer may be supported by a hypervisor that provides one or more virtual machines running on the device 900 to perform functions described herein. The virtualization layer may generally support a virtual resource that performs at least a portion of the techniques described herein.

Finally, in numerous additional embodiments, data may be processed into a format usable by one or more machine-learning models 926 (e.g., feature vectors), and or other pre-processing techniques. The one or more machine-learning models 926 may be any type of machine-learning model, such as supervised models, reinforcement models, and/or unsupervised models. The one or more machine-learning models 926 may include one or more of linear regression models, logistic regression models, decision trees, Naïve Bayes models, neural networks, k-means cluster models, random forest models, and/or other types of models.

In certain embodiments, one or more machine-learning models 926 can be utilized to enhance the software distribution and synchronization process. A machine-learning model 926 could be trained on synchronization data 932 captured previously and other network telemetry to predict potential failures or performance bottlenecks associated with a software update. For example, a trained model could analyze patterns across a fleet of devices and predict that a certain software update is likely to fail on a specific hardware revision or in a particular network configuration, which can allow a cloud controller to take pre-emptive action, such as adjusting the manifest or distribution strategy.

A machine-learning model 926 may also be used to optimize the distribution and state management process in some embodiments. For instance, the model could analyze network topology and real-time traffic data to select the most efficient local caching agent or to determine the optimal time to propagate updates to minimize operational impact. In a more advanced embodiment, a machine-learning model 926 could learn from ground truth data, such as administrator-verified successful deployments, to assist in the automatic generation or refinement of target state manifests. For example, it could learn the optimal combination of agent versions for a network that is intended to support specific, demanding AI workloads.

In summary, devices, networks, systems, methods, and processes for dynamically proxying traffic between interconnects of devices in a fabric are described herein. A communication network may include multiple switches, including gateway switches and non-gateway switches. Each switch can run a proxy agent for each port of the switch and for each link on each port. The switch may proxy data traffic within the communication network by utilizing the proxy agent. A non-gateway switch can send a connection request to a gateway switch to connect to an external cloud controller. The gateway switch may proxy the connection request to the external cloud controller and receive a session cookie. The non-gateway switch can establish a logical connection with the external cloud controller based on the session cookie.

Although a specific embodiment for a device suitable for configuration with an dynamic software distribution and synchronization logic 924 for carrying out the various steps, processes, methods, and operations described herein is discussed with respect to FIG. 9, any of a variety of systems and/or processes may be utilized in accordance with embodiments of the disclosure. For example, the device may be in a virtual environment such as a cloud-based network administration suite, or it may be distributed across a variety of network devices or switches. The elements depicted in FIG. 9 may also be interchangeable with other elements of FIGS. 1-8 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor; and
a memory communicatively coupled to the processor, wherein the memory comprises a dynamic software distribution and synchronization logic that is configured to:
identify a software state change of a network device;
generate a secure manifest configured for the network device;
select a distribution strategy;
propagate the secure manifest and one or more software objects; and
receive a synchronization report.

2. The device of claim 1, wherein the software state change is determined to be required.

3. The device of claim 1, wherein the network device is part of a network fabric.

4. The device of claim 3, wherein the distribution strategy comprises propagating the secure manifest and the one or more software objects to a local caching agent within the network fabric.

5. The device of claim 1, wherein the secure manifest is configured only for the network device.

6. The device of claim 1, wherein the secure manifest is propagated based on the selected distribution strategy.

7. The device of claim 1, wherein the synchronization report is received from the network device.

8. The device of claim 7, wherein the synchronization report comprises an indication of a success or a failure of a synchronization process performed by the network device.

9. The device of claim 1, wherein the dynamic software distribution and synchronization logic is further configured to determine if the software state change has been achieved.

10. The device of claim 1, wherein the secure manifest is cryptographically signed.

11. The device of claim 1, wherein the secure manifest comprises one or more cryptographic hashes, and wherein each of the one or more cryptographic hashes corresponds to one of the one or more software objects.

12. A device, comprising:
a processor; and
a memory communicatively coupled to the processor, wherein the memory comprises a dynamic software distribution and synchronization logic that is configured to:
receive a secure manifest;
authenticate the secure manifest;
retrieve one or more software objects;
execute a state synchronization process to apply one or more software objects;
validate the one or more software objects;
generate a synchronization report; and
transmit the synchronization report.

13. The device of claim 12, wherein the secure manifest is received from a cloud controller.

14. The device of claim 13, wherein the synchronization report is transmitted to the cloud controller.

15. The device of claim 12, wherein the secure manifest dictates the one or more software objects as required to satisfy the state synchronization process.

16. The device of claim 12, wherein authenticating the secure manifest comprises verifying a cryptographic signature of the secure manifest.

17. The device of claim 12, wherein retrieving the one or more software objects comprises retrieving the one or more software objects from a local caching agent.

18. The device of claim 12, wherein validating the one or more software objects comprises verifying one or more cryptographic hashes, and wherein the one or more cryptographic hashes are comprised in the secure manifest.

19. The device of claim 12, wherein executing the state synchronization process comprises saving a state of one or more existing agents prior to applying the one or more software objects.

20. A method of dynamic software distribution and synchronization, comprising:
identifying a software state change of a network device;
generating a secure manifest configured for the network device;
selecting a distribution strategy;
propagating the secure manifest and one or more software objects; and
receiving a synchronization report.
